(19) United States
(12) Patent Application Publication
(10) Pub. No.: US 2017/0030040 A1
(43) Pub. Date: Feb. 2, 2017

(54) SELF-FILLING FLOOD-PROTECTION BAG

(71) Applicant: LEVICE INVEST, S.R.O., Levice (SK)

(72) Inventors: Bohuslav Zuzi, Pezinok (SK); Adam Hajdu, Bratislava (SK)

(21) Appl. No.: 15/302,761

(22) PCT Filed: Apr. 9, 2015
(86) PCT No.: PCT/SK2015/000001

§ 371 Date: Oct. 7, 2016

(30) Foreign Application Priority Data
Apr. 9, 2014 (SK) PUV 50039-2014
Apr. 7, 2015 (SK) PP 21-2015

(51) Int. Cl. E02B 3/10; C08L 33/02; C08L 33/26; B01J 20/26; B01J 20/28

(52) U.S. Cl. CPC E02B 3/108; B01J 20/267; B01J 20/28016; B01J 20/28047; B01J 20/2805; C08L 33/26; C08L 33/02; E02B 2201/00; C08L 2205/02

(57) ABSTRACT

Self filling flood-protection bag consists of two enclosed chambers (1), that are interconnected by terminal yoke (2) in form of letter “T” and that are made of polyester fabric with high water absorbing capacity. Chambers (1) are filled up with granular or jelly mixture of water superabsorbents (3) based on cross-linked polyacrylate (SAP). Terminal yoke (2) contains two handling metal eyelets (4).

### TECHNICAL FIELD OF THE INVENTION

The invention relates generally to the field of water-resources management. More particularly, the invention relates to a construction of a self-filling flood-protection bag for the purpose of simple, fast and effective flood-protection of buildings, communications, agricultural areas, and which function is to eliminate, or at least help to minimize damages incurred during floods, emergency water leaks during failures in water supply systems and the like.

### BACKGROUND OF THE INVENTION

From the state of the art are known solid and transportable flood-protection barriers which are put together to form flood-protection walls. They are different types of walls anchored to solid or detachable supporting posts and different types of barriers filled with water or other material. Essentially, flood-protection means are flood-protection bags filled with sand, soil, crushed stone and other bulk material.

Also known are bags (pouches) fillable with water, that have the cross-section of a triangle that stands on the base, as described in Slovak utility model UV 6300. Keeping the shape of cross-section is possible to secure by the help of a carrier bar construction. The bag coat is made of polyethylene. These barriers occupy very large space by storage.

Known are also flexible plastic bags in the shape of pipes, as described in Slovak utility model UV 5855. These are filled with water and their advantage is their high ability for adaptation to terrain. Their disadvantage is that they can not be used for higher water column, by flowing through water are not sufficiently stable, and there is a threat of puncture in the plastic material caused by sharp material.

Known is also a system of open bags that have a trapezoid cross-section and are formed by a massive framework from steel pipes and a coat made from geotextile respectively coated with plastic material. They are filled with sand, soil, and water, respectively. Similar construction has also known segment of flood-protection wall, based on bag fillable with water, described in disclosed international patent application WO 02/10519. Their disadvantage consists in their low resistance against tension in the top parts of the cross-sections. For their fixation they require erection of supporting structure.

Another further known system of a flood-protection barrier is based on a construction of freely erected posts and cross bedded fillings. The disadvantage of this system consists in that there is necessary anchoring of brace rods for posts with the help of a massive framework.

Also known is the system of a flood-protection barrier consisting of the system of crossways, and firmly into the terrain are anchored supporting elements with defined spacing. To the line of such tailored crossway supporting elements is extended coat respectively even fixed with bags with sand.

Further is known the system of absorptive modules with block shape with water absorbent that are interconnected by fixation elements, for example by Velcro fasteners. The disadvantage of this system is the necessity of keeping the cleanliness of fixation elements so that they can safely fulfil the function of reliable interconnection of modules. There is also not a sufficiently secured interconnection of modules and the barrier built in this way is liable.

Limited options of flood-protection barriers relates to their mobility, which is influenced also by their firm anchoring into concrete as well as into infirm foundations and disadvantages resulting from the limitation of copying the irregularities within terrain. Also hard and bad manipulation with sand bags can cause health issues, requires a big number of working forces and at last also their poor storage ability and costs for transportation of sand, had created, need for development of such construction of flood-protection barriers, that would be mobile without firm anchoring elements, easily transportable, mountable, detachable and storable, and would be usable for firm, as well as infirm bedrock.

The result of this effort is a self-filling flood-protection bag further described in the present invention.

### SUMMARY OF THE INVENTION

Above mentioned disadvantages are removed by a self-filling flood-protection bag according to the present invention that is characterized in that it comprises at least two enclosed chambers that are interconnected by a terminal yoke in the form of a letter “T”, wherein the chambers are at least partially filled up with a mixture of water superabsorbents. The terminal yoke in the form of a letter “T” contains at least two handling metal or plastic eyelets. The eyelets serve for reinforcement of an erected flood-protection wall by pulling a rope through these eyelets, binding those self-filling flood-protection bags and allowing potential anchoring of the rope. The eyelets serve also for manipulation with those self-filling flood-protection bags during their removal. The water superabsorbent (SAP) itself can be in the form of moulded band, grid or in the form of granules or jelly. The mixture of water superabsorbents can be based on cross-linked polyacrylate such as polyacrylamide copolymers and polyacrylic acid, starch copolymers, carboxymethl cellulose, hydroxymethylcellulose, and modified cellulose. Into the chambers with the mixture of water, superabsorbents can be placed, also wetting agents, and/or polyvinylpyrrolidone that will assure, in the contact with water, fast swelling of superabsorbents. The self-filling flood-protection bag, i.e. chambers and/or also terminal yoke in the form of a letter “T” is made of polyester fabric with high water absorbing capacity within the whole module's profile and restrains leakage of jelly particles, superabsorbent granules to the surface of the self-filling flood-protection bags and thus significantly decreases slipping of filled up self-filling flood-protection bags.

Advantages of the construction of self-filling flood-protection bags, according to utility model are apparent from its effects that it manifests on the outside. Effects of the present invention consist before all in that the suggested constructional solution has a low weight suitable for transport and handling. They can be used immediately. Preparation of self-filling flood-protection bags for intervention requires, in practice, very low costs for work, handling and transport, because even thousands of self-filling flood-protection bags can be comfortably and quickly transported to the place of intervention. Storage of a large amount of self-filling flood-protection bags is very simple and long-term, more than 5 years. Their application is very simple, because deflated self-filling flood-protection bags contacted into water within 5 to 7 minutes, expand to full volume as a result of taken up water. Self-filling flood-protection bags can be used repeatedly and are environmentally acceptable. Considered is in particular, the usage of these self-filling flood-protection bags according to the present invention for:
Protection of residential, administrative and industrial objects;
Removal of contaminated waters;
Protection of swimming pools and bathing pools against penetrations of flood water;
Protection of channels and drain areas;
Absorption of flood and rainfall water from excavations;
Protection of building grounds, roads and buildings against waters;
Protection and drainage of underground garages and basements;
Deflection and regulation of water flow.

### BRIEF DESCRIPTION OF THE DRAWINGS

Self-filling flood-protection bag according to the invention will be further explained on particular embodiments shown on drawings, where:

FIG. 1 shows a three-dimensional view of one deflated self-filling flood-protection bag with two chambers and there is also shown a view in its cross-section A-A.

FIG. 2 shows detail B in cross-section of a self-filling flood-protection bag.

FIG. 3 shows a constructed flood-protection wall consisting of self-filling flood-protection bags stacked on each other.

### DETAILED DESCRIPTION OF EXEMPLARY EMBODIMENTS

It is understood that particular embodiments of self-filling flood-protection bags according to the invention are shown for illustrative purposes only and not as limiting technical solutions. Persons of skill in the art will find or will be able to find out under use of more or less routine experimentation, many equivalents of specific embodiments of self-filling flood-protection bags according to the invention. Also such equivalents will then be falling into the extent of the following patent claims. To the skilled persons in the art, they can-not encounter any difficulties dimensioning of such self-filling flood-protection bags, and suitable choice of materials and structural arrangements, thus these characteristics are not solved in details.

### Example 1

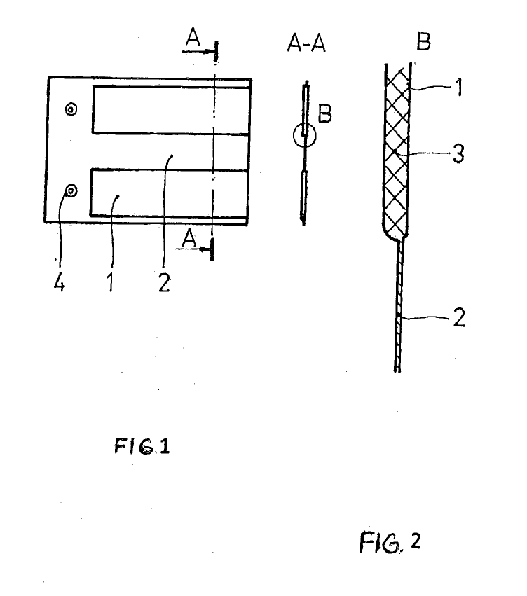

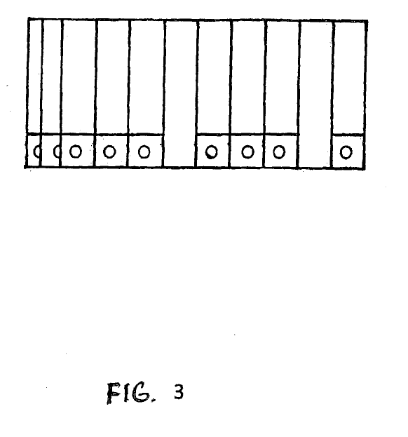

In this example of a particular embodiment of the subject of invention there is described a first arrangement of a self-filling flood-protection bag, as shown in FIGS. 1 and 2. This self-filling flood-protection bag consists of two enclosed chambers 1, that are interconnected by terminal yoke 2 in the form of a letter “T” and that are made of polyester fabric with high water absorbing capacity. Chambers 1 are filled up with granular or jelly mixture of water superabsorbents 3 based on cross-linked polyacrylates: polyacrylamide copolymers and polyacrylic acid together with polyvinylpyrrolidone. Terminal yoke 2 in the form of a letter “T” contains two handling metal eyelets 4. In FIG. 3 is shown a built-up flood-protection wall. It consists of self-filling flood-protection bags stacked on each other, where can be seen innovative function of terminal yokes 2, that provide stability, but also watertightness of stacked self-filling flood-protection bags, because terminal yokes 2, from one row, create gaps into which are occupied by chambers 1 of lower and higher row of stacked self-filling flood protection bags.

### Example 2

In this example of a particular embodiment of the subject of invention there is described a second arrangement of a self-filling flood-protection bag. This self-filling flood-protection bag is sufficiently described in the foregoing example. The difference consists only in the form of absorbent. In this case chambers 1 are filled-up with moulded water superabsorbent 3 in the shape of a latticed band. Another difference consists in that the terminal yoke 2 is made of plastic.

### Example 3

In this example of a particular embodiment of the subject of invention there is described a third arrangement of a self-filling flood-protection bag. This self-filling flood-protection bag is sufficiently described in the foregoing example. The difference consists only in the number of three chambers 1 interconnected by two terminal yokes 2 of self-filling flood-protection bag. Terminal yoke 2 in the form of a letter “T” contains three handling metal eyelets 4.

### INDUSTRIAL APPLICABILITY

The self-filling flood-protection bag according to the subject inventions finds application in the area of water-supply management for the construction of flood-protection dams and barriers and building industry for drying of sloppy and wet spaces.

1. A self-filling flood-protection bag, comprising: at least two enclosed chambers that are interconnected by a terminal yoke in the form of a letter “T”, where at least said enclosed chambers are formed from polyester fabric with high water absorbing capacity, and wherein said enclosed chambers are at least partially filled up with a mixture of water superabsorbent.

2. The self-filling flood-protection bag according to claim 1, wherein said terminal yoke in the form of a letter “T” is formed of a polyester fabric with high water absorbing capacity and has at least two handling eyelets.

3. The self-filling flood-protection bag according to patent claim 1, the wherein said terminal yoke in the form of a letter “T” is made of plastic and has at least two handling eyelets.

4. The self-filling flood-protection bag according to patent claim 1, wherein said water expanding superabsorbent is in the form of moulded band, granules or jelly.

5. The self-filling flood-protection bag according to patent claim 1, wherein said water expanding superabsorbent is based on cross-linked polyacrylate.

6. The self-filling flood-protection bag according to patent claim 1, wherein within said enclosed chambers are placed wetting agents and/or polyvinylpyrrolidone.

7. The self-filling flood-protection bag according to claim 2 wherein with said enclosed chambers are placed wetting agents and/or polyvinylpyrrolidone.

8. The self-filling flood-protection bag according to claim 3 wherein with said enclosed chambers are placed wetting agents and/or polyvinylpyrrolidone.

9. The self-filling flood-protection bag according to claim 4 wherein with said enclosed chambers are placed wetting agents and/or polyvinylpyrrolidone.

10. The self-filling flood-protection bag according to claim 4 wherein with said enclosed chambers are placed wetting agents and/or polyvinylpyrrolidone.
